(19) United States
(12) Patent Application Publication
(10) Pub. No.: US 2025/0188231 A1
(43) Pub. Date: Jun. 12, 2025

(54) METAL/GLASS FIBER-REINFORCED THERMOPLASTIC RESIN COMPOSITE MATERIAL

(71) Applicant: NITTO BOSEKI CO., LTD., FUKUSHIMA-SHI, FUKUSHIMA (JP)

(72) Inventor: Yosuke NUKUI, FUKUSHIMA-SHI, FUKUSHIMA (JP)

(21) Appl. No.: 18/838,077

(22) PCT Filed: Oct. 28, 2022
(86) PCT No.: PCT/JP2022/040430

§ 371 Date: Feb. 24, 2025

(30) Foreign Application Priority Data
Jun. 22, 2022 (JP) 2022-100017

(51) Int. Cl. C08J 5/04; C08K 7/14

(52) U.S. Cl. CPC C08J 5/043; C08J 5/041; C08K 7/14; C08J 2367/02; C08J 2369/00; C08J 2377/00; C08J 2381/04; C08K 2201/003; C08K 2201/004

(57) ABSTRACT

Provided is a metal-glass fiber-reinforced thermoplastic resin composite material in which productivity of glass fiber, and mechanical strength of a glass fiber-reinforced thermoplastic resin material are high, and excellent heat cycle resistance is provided between a metal material and the glass fiber-reinforced thermoplastic resin material. The metal-glass fiber-reinforced thermoplastic resin composite material includes a metal material, and a glass fiber-reinforced thermoplastic resin material, wherein a difference ΔT between a 500 poise temperature T1 and a 10000 poise temperature T2 of glass fiber included in the glass fiber-reinforced thermoplastic resin material is 162 to 181° C., a glass filament has a ratio (long diameter/short diameter) A of a long diameter to a short diameter thereof of 1.5 to 4.5, and a glass content C of the glass fiber-reinforced thermoplastic resin material is 20.0 to 65.0% by mass.

### TECHNICAL FIELD

The present invention relates to a metal-glass fiber-reinforced thermoplastic resin composite material.

### BACKGROUND ART

Conventionally, glass fiber has been widely used in various applications to improve the strength of resin materials. In recent years, applications of glass fiber-reinforced resin materials have been expanded to applications as metal substitute materials. For members required to have a particularly high mechanical strength, use of a composite material formed by bonding and integrating a metal material and a glass fiber-reinforced thermoplastic resin material (metal-glass fiber-reinforced thermoplastic resin composite material) has been contemplated (e.g., see Patent Literature 1 and Patent Literature 2).

### CITATION LIST

### Patent Literature

Patent Literature 1: Japanese Patent Laid-Open No. 2005-161693

Patent Literature 2: WO 2020/004597

### SUMMARY OF INVENTION

### Technical Problem

However, the metal-glass fiber-reinforced thermoplastic resin composite material has disadvantages that, in association with expansion/contraction of a thermoplastic resin, interfacial delamination of a sub-micron level is likely to occur at the interface between the metal material and the glass fiber-reinforced thermoplastic resin material, and a bonding force obtained between the metal material and the glass fiber-reinforced thermoplastic resin material under heat cycles (which is also referred to as the heat cycle resistance) is small.

Besides, although some types of glass fiber used therein may improve the heat cycle resistance of the metal-glass fiber-reinforced thermoplastic resin composite material, there may be disadvantages that the productivity of the glass fiber may deteriorate, and the mechanical strength of the glass fiber-reinforced thermoplastic resin material may be reduced.

An object of the present invention is to provide, by eliminating these disadvantages, a metal-glass fiber-reinforced thermoplastic resin composite material in which productivity of glass fiber is high, the mechanical strength of a glass fiber-reinforced thermoplastic resin material is high, and excellent heat cycle resistance can be provided between a metal material and the glass fiber-reinforced thermoplastic resin material.

### Solution to Problem

In order to achieve the object, a metal-glass fiber-reinforced thermoplastic resin composite material of the present invention is a metal-glass fiber-reinforced thermoplastic resin composite material comprising a metal material, and a glass fiber-reinforced thermoplastic resin material disposed on at least one side of the metal material, wherein a difference ΔT (ΔT=T1−T2) between a 500 poise temperature T1 and a 10000 poise temperature T2 of glass fiber included in the glass fiber-reinforced thermoplastic resin material is in the temperature range of 157 to 186° C., a glass filament constituting the glass fiber has a flat cross-sectional shape having a ratio (long diameter/short diameter) A of a long diameter to a short diameter of the glass filament in the range of 1.5 to 4.5, and a glass content C of the glass fiber-reinforced thermoplastic resin material is in the range of 20.0 to 65.0% by mass.

Since the metal-glass fiber-reinforced thermoplastic resin composite material of the present invention has the above-described configuration, the productivity of the glass fiber, and the mechanical strength of the glass fiber-reinforced thermoplastic resin material are high, and excellent heat cycle resistance can be provided between the metal material and the glass fiber-reinforced thermoplastic resin material.

The glass fiber can be produced by bundling glass filaments that are produced by supplying a prescribed glass material (glass batch) to a melting furnace, discharging the thus molten glass batch (molten glass) through a nozzle tip or a hole, and cooling and solidifying the resultant while stretching. Here, the operation of discharging the molten glass through a nozzle tip or a hole, and cooling and solidifying the resultant while stretching to form the glass filament is referred to as “spinning”.

In the spinning, when the nozzle tip or the hole has a non-circular shape, and has a projection or a notch for rapidly cooling the molten glass, a glass filament having a non-circular cross section, for example, a flat cross section, can be obtained by controlling temperature conditions.

The metal-glass fiber-reinforced thermoplastic resin composite material of the present invention can be obtained, for example, by fitting a metal material inside a mold of an injection molding machine, feeding a resin pellet having a predetermined glass content and obtained by kneading glass fiber and a thermoplastic resin in a twin-screw kneader, and subjecting the resultant to insert molding.

Here, high productivity of the glass fiber refers to the following: When a prescribed glass cullet is charged in a platinum container, the glass cullet is melted by heating the platinum container to a temperature in the range of 1200 to 1450° C., the thus obtained molten glass is drawn through a nozzle tip of the platinum container to be wound around a winding device, and the molten glass is wound by rotating the winding device for 1 hour at a rotational speed of 1100 rpm, the spinning can be conducted continuously for 1 hour without cutting. The glass cullet is produced by placing, in a platinum crucible, a glass raw material (glass batch) having been prepared into a prescribed glass composition, and melting the material, with stirring, in an electric furnace by keeping a temperature of 1650° C. for 6 hours to obtain homogenous molten glass, and pouring the molten glass onto a carbon plate.

Besides, high mechanical strength of the glass fiber-reinforced thermoplastic resin material refers to the following: When the resin pellet used in producing the metal-glass fiber-reinforced thermoplastic resin composite material of the present invention is subjected to injection molding to produce a type A dumbbell test piece (thickness: 4 mm) in accordance with JIS K 7165: 2008, a measurement obtained from the type A dumbbell test piece by a static tensile test in accordance with JIS K 7171: 2016 under a condition of a test temperature of 23° C. is in the range of 180 MPa or more.

Besides, the metal-glass fiber-reinforced thermoplastic resin composite material having excellent heat cycle resistance provided between the metal material and the glass fiber-reinforced thermoplastic resin material means the following: In a low and high temperature resistance test described below, break does not occur in the interface between the metal material and the glass fiber-reinforced thermoplastic resin material of the metal-glass fiber-reinforced thermoplastic resin composite material in the range within 48 cycles.

In the metal-glass fiber-reinforced thermoplastic resin composite material of the present invention, the glass content in the glass fiber-reinforced thermoplastic resin material can be calculated in accordance with JIS K 7052: 1999 from the glass fiber-reinforced thermoplastic resin material separated from the metal-glass fiber-reinforced thermoplastic resin composite material.

Besides, in the metal-glass fiber-reinforced thermoplastic resin composite material of the present invention, the glass fiber included in the glass fiber-reinforced thermoplastic resin material has a Vickers hardness H in the range of 700 to 800 HV0.2, and the A, the C, the ΔT, and the H preferably satisfy the following formula (1), and more preferably satisfy the following formula (2):

$$6.53 \leq H \times {C}^{1 / 2} / ( A \times Δ T ) \leq 13 \text{.45} \qquad ( 1 )$$

$$5.72 \leq H \times {C}^{1 / 2} / ( A \times Δ T ) \leq 9.83 \qquad ( 2 )$$

The Vickers hardness H of the glass fiber included in the glass fiber-reinforced thermoplastic resin material can be measured by the following method.

### Vickers Hardness H

First, the glass fiber-reinforced thermoplastic resin material is separated from the metal-glass fiber-reinforced thermoplastic resin composite material with a cutting machine or the like. Then, the glass fiber-reinforced thermoplastic resin material is heated, for example, in a muffle furnace at 300 to 650° C. for about 0.5 to 24 hours to decompose an organic matter.

Next, the remaining glass fiber is placed in a platinum crucible and melted with stirring while being held at a temperature of 1600° C. for 6 hours in an electric furnace to obtain a homogeneous molten glass. Next, the platinum crucible holding the molten glass is taken out of the electric furnace to cool the molten glass. Then, the molten glass is tapped out of the platinum crucible, heated at a strain removal temperature in the range of 660 to 750° C. for 2 hours in order to remove the strain of the glass, and the resultant is cooled to room temperature (20 to 25° C.) over 8 hours to obtain a glass mass.

Next, the obtained glass mass is processed into a test piece of 3 mm in width, 80 mm in length, and 1 mm in thickness using a cutting machine, for example, a diamond cutter and a grinder. Then, in accordance with JIS Z 2244:2020, in at least 5 points on the surface of the obtained test piece, the Vickers hardness HV0.2 is measured using a Vickers hardness tester (manufactured by Mitutoyo Corporation, product name: HM-220) under conditions of a load applied of 0.2 kgf and a load time of 15 seconds. Next, the average value of measurements thus obtained is calculated to obtain the Vickers hardness H of the glass fiber. It is noted that “0.2” of HV0.2 corresponds to the magnitude (kgf) of an applied load.

In the metal-glass fiber-reinforced thermoplastic resin composite material of the present invention, when the glass fiber included in the glass fiber-reinforced thermoplastic resin material has the Vickers hardness H falling in the above-described range, and the A, the C, the ΔT, and the H satisfy the formula (1), the productivity of the glass fiber, and the mechanical strength of the glass fiber-reinforced thermoplastic resin material are high, and excellent heat cycle resistance can be provided between the metal material and the glass fiber-reinforced thermoplastic resin material.

In the metal-glass fiber-reinforced thermoplastic resin composite material of the present invention, when the glass fiber included in the glass fiber-reinforced thermoplastic resin material has the Vickers hardness H falling in the above-described range, and the A, the C, the ΔT, and the H satisfy the formula (2), the productivity of the glass fiber is high, the mechanical strength of the glass fiber-reinforced thermoplastic resin material is higher, and more excellent heat cycle resistance can be provided between the metal material and the glass fiber-reinforced thermoplastic resin material.

Here, the mechanical strength of the glass fiber-reinforced thermoplastic resin material being higher refers to that a measurement obtained from the type A dumbbell test piece by the statistic tensile test is in the range of 190 MPa or more.

Besides, the metal-glass fiber-reinforced thermoplastic resin composite material having more excellent heat cycle resistance provided between the metal material and the glass fiber-reinforced thermoplastic resin material refers to that break does not occur in the interface between the metal material and the glass fiber-reinforced thermoplastic resin material of the metal-glass fiber-reinforced thermoplastic resin composite material in the range within 168 cycles or less in the low and high temperature resistance test described below.

Besides, in the metal-glass fiber-reinforced thermoplastic resin composite material of the present invention, the thermoplastic resin included in the glass fiber-reinforced thermoplastic resin material is preferably one thermoplastic resin selected from the group consisting of polyphenylene sulfide, polyamide, polybutylene terephthalate, and polycarbonate, and more preferably polyphenylene sulfide, or polybutylene terephthalate.

### DESCRIPTION OF EMBODIMENTS

Hereinafter, embodiments of the present invention will be described in detail.

A metal-glass fiber-reinforced thermoplastic resin composite material of the present embodiment is a metal-glass fiber-reinforced thermoplastic resin composite material comprising a metal material, and a glass fiber-reinforced thermoplastic resin material disposed on at least one side of the metal material, wherein a difference ΔT (ΔT=T1−T2) between a 500 poise temperature T1 and a 10000 poise temperature T2 of glass fiber included in the glass fiber-reinforced thermoplastic resin material is in the temperature range of 157 to 186° C., a glass filament constituting the glass fiber has a flat cross-sectional shape having a ratio (long diameter/short diameter) A of a long diameter to a short diameter of the glass filament in the range of 1.5 to 4.5, and a glass content C of the glass fiber-reinforced thermoplastic resin material is in the range of 20.0 to 65.0% by mass.

Since the metal-glass fiber-reinforced thermoplastic resin composite material of the present embodiment has the above-described configuration, the productivity of the glass fiber, and the mechanical strength of the glass fiber-reinforced thermoplastic resin material are high, and excellent heat cycle resistance can be provided between a metal material and the glass fiber-reinforced thermoplastic resin material.

In the metal-glass fiber-reinforced thermoplastic resin composite material of the present embodiment, when the glass fiber included in the glass fiber-reinforced thermoplastic resin material has the ΔT of a temperature in the range of more than 186° C., the glass filament can be cut during the spinning. The glass filament is cut during the spinning probably because the viscosity of the molten glass is sensitive to temperature change, and hence the viscosity of the molten glass discharged through a nozzle is largely changed due to influence of a small temperature change in the space in the vicinity of the nozzle for discharging the molten glass.

On the other hand, when the ΔT is a temperature in the range of less than 157° C., a glass filament having a modified cross section with the ratio (long diameter/short diameter) A of the long diameter to the short diameter of the glass filament falling in the above-described range cannot be obtained. A glass filament having the modified cross section cannot be obtained probably because the viscosity of the molten glass is not changed in accordance with the temperature, and hence the cross-sectional shape of the glass filament is difficult to be modified.

The ΔT is preferably a temperature in the range of 165 to 175° C. It is noted that as the content of SiO₂ with respect to the total amount of the glass fiber is increased, the 10000 pose temperature T2 is largely increased, and hence the ΔT tends to reduce. Besides, as the content of CaO with respect to the total amount of the glass fiber is increased, the 500 poise temperature T1 is largely reduced, and hence the ΔT tends to reduce. Accordingly, the ΔT can be adjusted by changing the content of SiO₂ and the content of CaO with respect to the total amount of the glass fiber.

In the metal-glass fiber-reinforced thermoplastic resin composite material of the present embodiment, when the glass fiber included in the glass fiber-reinforced thermoplastic resin material has the ratio (long diameter/short diameter) A of the long diameter to the short diameter of the glass filament constituting the glass fiber falling in the range of more than 4.5, the number of times of cutting occurring during the production of the glass filament is increased, which reduces the productivity. On the other hand, when the glass fiber included in the glass fiber-reinforced thermoplastic resin material has the ratio (long diameter/short diameter) A of the long diameter to the short diameter of the glass filament constituting the glass fiber falling in the range of less than 1.5, the heat cycle resistance of the metal-glass fiber-reinforced thermoplastic resin composite material deteriorates.

The ratio (long diameter/short diameter) A of the long diameter to the short diameter of the glass filament constituting the glass fiber is preferably in the range of 2.2 to 3.9, more preferably in the range of 2.4 to 3.7, further preferably in the range of 2.5 to 3.5, particularly preferably in the range of 2.8 to 3.4, and most preferably in the range of 2.9 to 3.3.

Examples of the flat cross-sectional shape of the glass filament constituting the glass fiber included in the glass fiber-reinforced thermoplastic resin material of the present embodiment include a long-oval (a shape obtained by substituting short sides of a rectangle respectively with semicircles having a diameter corresponding to the short side), an ellipse, and a rectangle, and a long-oval is preferred because this shape makes a contribution to improvement of fluidity of the glass fiber-reinforced thermoplastic resin material. It is noted that the cross section of a glass filament herein means a cross section vertical to the fiber length direction of the glass filament.

The short diameter of the glass filament having the flat cross-sectional shape used in the glass fiber-reinforced thermoplastic resin material of the present embodiment is in the range of 4.0 to 14.0 μm, preferably in the range of 4.8 to 11.5 μm, more preferably in the range of 7.5 to 10.0 μm, and further preferably in the range of 8.1 to 9.5 μm. On the other hand, the long diameter of the glass filament having the flat cross-sectional shape is in the range of 12.0 to 40.0 μm, preferably in the range of 19.5 to 36.0 μm, more preferably in the range of 27.4 to 32.0 μm, and further preferably in the range of 28.1 to 29.2 μm.

A converted fiber diameter of the glass filament having the flat cross-sectional shape used in the glass fiber-reinforced thermoplastic resin material of the present embodiment is, for example, in the range of 5.0 to 25.0 μm, preferably in the range of 8.0 to 22.0 μm, more preferably in the range of 10.0 to 18.0 μm, and further preferably in the range of 11.0 to 15.0 μm. Here, the term “converted fiber diameter” means the diameter of a glass filament having a circular cross section, but having the same cross-sectional area as the cross section of the glass filament having the flat cross-sectional shape.

The short diameter and the long diameter of the glass filament having the flat cross-sectional shape used in the glass fiber-reinforced thermoplastic resin material of the present embodiment can be calculated, for example, as follows. First, a cross section of the glass fiber-reinforced thermoplastic resin material is polished. Next, in the cross section of the glass fiber-reinforced thermoplastic resin material, long diameters and short diameters of 100 or more glass filaments are measured with an electron microscope. At this point, the longest side passing through substantially the center of the cross section of the glass filament is determined as the long diameter, a side crossing the long diameter at a right angle at substantially the center of the cross section of the glass filament is determined as the short diameter, and these lengths are respectively measured. Then, an average value of these lengths is obtained, and thus, the short diameter and the long diameter of the glass filament can be calculated.

In the metal-glass fiber-reinforced thermoplastic resin composite material of the present embodiment, when the glass content C of the glass fiber-reinforced thermoplastic resin material is in the range of more than 65.0% by mass, the heat cycle resistance of the metal-glass fiber-reinforced thermoplastic resin composite material deteriorates. On the other hand, when the glass content C of the glass fiber-reinforced thermoplastic resin material is in the range of less than 20.0% by mass, the bending strength of the glass fiber-reinforced thermoplastic resin material is insufficient.

The glass content C of the glass fiber-reinforced thermoplastic resin material is preferably in the range of 25.0 to 52.0% by mass, more preferably in the range of 31.0 to 48.0% by mass, and further preferably in the range of 35.0 to 45.0% by mass.

In the metal-glass fiber-reinforced thermoplastic resin composite material of the present embodiment, the glass fiber included in the glass fiber-reinforced thermoplastic resin material has the Vickers hardness H falling in the range of 700 to 800 HV0.2, and the A, the C, the ΔT and the H preferably satisfy the following formula (1), and more preferably satisfy the following formula (2):

$$6.53 \leq H \times {C}^{1 / 2} / ( A \times Δ T ) \leq 13 \text{.45} \qquad ( 1 )$$

$$5.72 \leq H \times {C}^{1 / 2} / ( A \times Δ T ) \leq 9.83 \qquad ( 2 )$$

In the metal-glass fiber-reinforced thermoplastic resin composite material of the present embodiment, the Vickers hardness H of the glass fiber included in the glass fiber-reinforced thermoplastic resin material is more preferably in the range of 705 to 755 HV0.2, further preferably in the range of 720 to 750 HV0.2, and particularly preferably in the range of 730 to 745 HV0.2.

It is noted that the Vickers hardness H is largely affected by the content of SiO₂ with respect to the total amount of the glass fiber, and tends to increase as the content of SiO₂ with respect to the total amount of the glass fiber increases. Besides, the Vickers hardness H tends to increase as the content of CaO with respect to the total amount of the glass fiber increases. Accordingly, the Vickers hardness H can be adjusted to a desired value by adjusting the content of SiO₂ with respect to the total amount of the glass fiber, and can be further finely adjusted by adjusting the content of CaO with respect to the total amount of the glass fiber.

In general, the glass fiber makes a larger contribution to the rigidity of the glass fiber-reinforced thermoplastic resin material than the thermoplastic resin, and therefore, when the C increases, the rigidity of the glass fiber-reinforced thermoplastic resin material is increased. Accordingly, H×C^{1/2}probably denotes the rigidity of the glass fiber-reinforced thermoplastic resin material. As the rigidity is higher, the glass fiber-reinforced thermoplastic resin material is improved in the strength, but the toughness is reduced, and thus the heat cycle resistance of the metal-glass fiber-reinforced thermoplastic resin composite material tends to deteriorate.

A×ΔT denotes equilibrium between the productivity of the glass fiber and the heat cycle resistance of the metal-glass fiber-reinforced thermoplastic resin composite material. As A×ΔT is larger, the number of cutting of a glass filament occurring in producing the glass fiber is increased, and hence the productivity of the glass fiber deteriorates. On the other hand, when A×ΔT is too small, the heat cycle resistance of the metal-glass fiber-reinforced thermoplastic resin composite material tends to deteriorate.

In considering these, H×C^{1/2}/(A×ΔT) probably denotes equilibrium among the heat cycle resistance of the metal-glass fiber-reinforced thermoplastic resin composite material, the productivity of the glass fiber, and the strength of the glass fiber-reinforced thermoplastic resin material.

Besides, in the metal-glass fiber-reinforced thermoplastic resin composite material of the present embodiment, when the glass fiber included in the glass fiber-reinforced thermoplastic resin material has the Vickers hardness H falling in the above-described range, the A, the C, the ΔT, and the H further preferably satisfy the following formula (3), and particularly preferably satisfy the following formula (4):

$$7.04 \leq H \times {C}^{1 / 2} / ( A \times Δ T ) \leq 9 \text{.77} \qquad ( 3 )$$

$$8.33 \leq H \times {C}^{1 / 2} / ( A \times Δ T ) \leq 9.40 \qquad ( 4 )$$

In the metal-glass fiber-reinforced thermoplastic resin composite material of the present embodiment, the thermoplastic resin included in the glass fiber-reinforced thermoplastic resin material is preferably one thermoplastic resin selected from the group consisting of polyphenylene sulfide, polyamide, polybutylene terephthalate, and polycarbonate, and more preferably polyphenylene sulfide, or polybutylene terephthalate.

In the glass composition of the glass fiber of the present embodiment, the content of SiO₂ with respect to the total amount of the glass fiber is preferably in the range of 50 to 60% by mass, and more preferably in the range of 52 to 58% by mass. When the content of SiO₂ with respect to the total amount of the glass fiber is less than 50% by mass, the strength of the glass fiber tends to reduce. On the other hand, when the content of SiO₂ with respect to the total amount of the glass fiber is more than 60% by mass, the viscosity of the molten glass increases, and hence the productivity of the glass fiber tends to deteriorate. It is noted that the glass composition of the glass fiber of the present embodiment is completely identical to the glass composition of the glass filament constituting the glass fiber of the present embodiment.

In the glass composition of the glass fiber of the present embodiment, the content of CaO with respect to the total amount of the glass fiber is preferably in the range of 14 to 32% by mass, more preferably in the range of 18 to 28% by mass, and further preferably in the range of 20 to 26% by mass. When the content of CaO with respect to the total amount of the glass fiber is less than 14% by mass, the viscosity of the molten glass increases, and hence the productivity of the glass fiber tends to deteriorate. On the other hand, when the content of CaO with respect to the total amount of the glass fiber is more than 32% by mass, crystal is easily generated in the glass filament constituting the glass fiber during the production of the glass fiber, and hence the productivity of the glass fiber tends to deteriorate.

Besides, the glass composition of the glass fiber of the present embodiment may have an additional composition in addition to SiO₂ and CaO. The additional composition is not especially limited, and examples include Al₂O₃, and MgO.

In the glass fiber of the present embodiment, regarding the measurement of the contents of the aforementioned components, the content of Li as a light element can be measured with an ICP emission spectroscopic analyzer. The contents of the other elements can be measured with a wavelength dispersive X-ray fluorescence analyzer.

An example of the measurement method includes the following. First, a glass batch is placed in a platinum crucible, and melted, with stirring, by keeping a temperature of 1550° C. for 4 hours, and a temperature of 1650° C. for 2 hours in an electric furnace, and thus homogeneous molten glass is obtained. Alternatively, the glass fiber is placed in a platinum crucible, and melted, with stirring, by keeping a temperature of 1600° C. for 4 hours in an electric furnace, and thus homogeneous molten glass is obtained.

The glass batch is a raw material for forming the glass fiber, or the glass filament constituting the glass fiber, and is prepared by mixing glass raw materials to obtain a glass composition for glass fiber having a desired composition. Besides, when an organic matter adheres to the surface of the glass fiber, or when the glass fiber is included, mainly as a reinforcing material, in an organic matter (resin), the glass fiber is used after removing the organic matter by, for example, heating for a time period in the range of about 0.5 to 24 hours in a muffle furnace at a temperature in the range of 300 to 650° C.

Next, the obtained molten glass is poured onto a carbon plate to produce a glass cullet, which is pulverized and powdered into a glass powder.

Next, regarding Li as the light element, the glass powder is thermally decomposed with an acid, and then quantitative analysis is conducted with an ICP emission spectroscopic analyzer. Regarding the other elements, the glass powder is molded into a disc shape with a pressing machine, and then quantitative analysis is conducted with a wavelength dispersive X-ray fluorescence analyzer. Specifically, in the quantitative analysis with the wavelength dispersive X-ray fluorescence analyzer, a calibration curve sample is prepared based on a result obtained by measurement by the fundamental parameter method, and the analysis can be conducted by a calibration curve method. It is noted that the content of each component in the calibration curve sample can be quantitatively analyzed with an ICP emission spectroscopic analyzer. Based on the results of such quantitative analyses, the contents of the respective components and the total amount are calculated in terms of oxide, and from the thus obtained values, the contents (% by mass) of the above-described respective components can be obtained.

An example of a preferable form of the glass fiber (also referred to as the glass fiber bundle or glass strand) included in the glass fiber-reinforced thermoplastic resin material of the present embodiment before molding processing includes a chopped strand in which the number of glass filaments constituting the glass fiber (number bundled) is within a prescribed range, and that is cut into a prescribed length. In the chopped strand, the number of glass filaments constituting the glass fiber is preferably in the range of 1 to 20000, more preferably in the range of 50 to 10000, and further preferably in the range of 1000 to 8000. In the chopped strand, the cut length of the glass fiber is preferably in the range of 1.0 to 100.0 mm, more preferably in the range of 1.2 to 51.0 mm, further preferably in the range of 1.5 to 30.0 mm, particularly preferably in the range of 2.0 to 15.0 mm, and most preferably in the range of 2.3 to 7.8 mm.

Besides, other examples of the form of the glass fiber included in the glass fiber-reinforced thermoplastic resin material of the present embodiment before molding processing include, in addition to the chopped strand, a roving and cut fiber. The roving is a form in which the number of glass filaments constituting the glass fiber is 10 to 30000, and that is not cut. The cut fiber is a form in which the number of glass filaments constituting the glass fiber is 1 to 20000, and that is pulverized into a length in the range of 0.001 to 0.900 mm by a known method using a ball mill, a Henschel mixer, or the like.

The glass fiber included in the glass fiber-reinforced thermoplastic resin material of the present embodiment may be coated with an organic matter on the surface thereof for the purposes of improvement of adhesiveness between the glass fiber and the resin, and improvement of uniform dispersibility of the glass fiber in a mixture of the glass fiber and the resin. Examples of such an organic matter include resins such as a urethane resin, an epoxy resin, a vinyl acetate resin, an acrylic resin, modified polypropylene (particularly carboxylic acid-modified polypropylene), and a copolymer of (poly) carboxylic acid (particularly maleic acid) and an unsaturated monomer, and a silane coupling agent.

The glass fiber included in the glass fiber-reinforced thermoplastic resin material of the present embodiment may be coated with a composition including a lubricant, a surfactant, and the like, in addition to these resins or a silane coupling agent. Such a composition covers the glass fiber at a rate of 0.1 to 2.0% by mass based on the mass of the glass fiber in a state not coated with the composition.

Here, examples of the silane coupling agent include aminosilanes, chlorosilanes, epoxysilanes, mercaptosilanes, vinylsilanes, acrylsilanes, and cationic silanes.

Examples of the aminosilane include γ-aminopropyltriethoxysilane, N-β-(aminoethyl)-γ-aminopropyltrimethoxysilane, N-β-(aminoethyl)-N′-β-(aminoethyl)-γ-aminopropyltrimethoxysilane, and γ-anilinopropyltrimethoxysilane.

Examples of the chlorosilane include γ-chloropropyltrimethoxysilane.

Examples of the epoxy silane include γ-glycidoxypropyltrimethoxysilane and β-(3,4-epoxy cyclohexyl)ethyltrimethoxysilane.

Examples of the mercaptosilane include γ-mercaptotrimethoxysilane.

Examples of the vinyl silane include vinyl trimethoxysilane and N-β-(N-vinylbenzylaminoethyl)-γ-aminopropyltrimethoxysilane.

Examples of the cationic silane include N-(vinylbenzyl)-2-aminoethyl-3-aminopropyltrimethoxysilane hydrochloride and N-phenyl-3-aminopropyltrimethoxysilane hydrochloride.

In the present embodiment, one of the silane coupling agents may be singly used, or two or more of these may be used in combination.

Examples of the lubricant include modified silicone oils, animal oils and hydrogenated products thereof, vegetable oils and hydrogenated products thereof, animal waxes, vegetable waxes, mineral waxes, condensates of a higher saturated fatty acid and a higher saturated alcohol, polyethyleneimine, polyalkylpolyamine alkylamide derivatives, fatty acid amides, and quaternary ammonium salts.

Examples of the animal oil include beef tallow.

Examples of the vegetable oil include soybean oil, coconut oil, rapeseed oil, palm oil, and castor oil.

Examples of the animal wax include beeswax and lanolin.

Examples of the vegetable wax include candelilla wax and carnauba wax.

Examples of the mineral wax include paraffin wax and montan wax.

Examples of the condensate of a higher saturated fatty acid and a higher saturated alcohol include stearates such as lauryl stearate.

Examples of the fatty acid amide include dehydrated condensates of polyethylenepolyamines such as diethylenetriamine, triethylenetetramine, and tetraethylenepentamine and fatty acids such as lauric acid, myristic acid, palmitic acid, and stearic acid.

Examples of the quaternary ammonium salt include alkyltrimethylammonium salts such as lauryltrimethylammonium chloride.

In the present embodiment, one of the lubricants may be singly used, or two or more of these may be used in combination.

Examples of the surfactant include nonionic surfactants, cationic surfactants, anionic surfactants, and amphoteric surfactants.

Examples of the nonionic surfactant can include ethylene oxide propylene oxide alkyl ether, polyoxyethylene alkyl ether, polyoxyethylene-polyoxypropylene-block copolymer, alkyl polyoxyethylene-polyoxypropylene block copolymer ether, polyoxyethylene fatty acid ester, polyoxyethylene fatty acid monoester, polyoxyethylene fatty acid diester, polyoxyethylene sorbitan fatty acid ester, glycerol fatty acid ester ethylene oxide adduct, polyoxyethylene castor oil ether, hydrogenated castor oil ethylene oxide adduct, alkylamine ethylene oxide adduct, fatty acid amide ethylene oxide adduct, glycerol fatty acid ester, polyglycerol fatty acid ester, pentaerythritol fatty acid ester, sorbitol fatty acid ester, sorbitan fatty acid ester, sucrose fatty acid ester, polyhydric alcohol alkyl ether, fatty acid alkanolamide, acetylene glycol, acetylene alcohol, ethylene oxide adduct of acetylene glycol, and ethylene oxide adduct of acetylene alcohol.

Examples of the cationic surfactant can include alkyldimethylbenzylammonium chloride, alkyltrimethylammonium chloride, alkyl dimethyl ethyl ammonium ethyl sulfate, higher alkylamine acetate, higher alkylamine hydrochloride, adduct of ethylene oxide to a higher alkylamine, condensate of a higher fatty acid and polyalkylene polyamine, a salt of an ester of a higher fatty acid and alkanolamine, a salt of higher fatty acid amide, imidazoline cationic surfactant, and alkyl pyridinium salt.

Examples of the anionic surfactant can include higher alcohol sulfate salts, higher alkyl ether sulfate salts, α-olefin sulfate salts, alkylbenzene sulfonate salts, α-olefin sulfonate salts, reaction products of fatty acid halide and N-methyl taurine, dialkyl sulfosuccinate salts, higher alcohol phosphate ester salts, and phosphate ester salts of higher alcohol ethylene oxide adduct.

Examples of the amphoteric surfactant can include amino acid amphoteric surfactants such as alkali metal salts of alkylaminopropionic acid, betaine amphoteric surfactants such as alkyldimethylbetaine, and imidazoline amphoteric surfactants.

In the metal-glass fiber-reinforced thermoplastic resin composite material of the present embodiment, the metal material is preferably aluminum, an aluminum alloy, or stainless steel. Examples of the aluminum can include A1050 and A1100. Examples of the aluminum alloy can include A1200, A2017, A2024, A3003, A3004, A4032, A5005, A5052, A5083, A6061, A6063, and A7075. Examples of the stainless steel can include SUS301, SUS304, SUS316, and SUS316L. The metal material is preferably aluminum or an aluminum alloy because of a high degree of improvement of the heat cycle resistance.

In the metal-glass fiber-reinforced thermoplastic resin composite material of the present embodiment, an absolute value of a difference between a linear expansion coefficient of the metal material and an average linear expansion coefficient of the glass fiber-reinforced thermoplastic resin material is, for example, 4.5×10⁻⁵/° C. or less. Besides, the absolute value of the difference between the linear expansion coefficient of the metal material and the average linear expansion coefficient of the glass fiber-reinforced thermoplastic resin material is preferably 3.0×10⁻⁵/° C. or less because of a high degree of improvement of the heat cycle resistance. Here, the linear expansion coefficient of the metal material can be measured in accordance with JIS Z 2285: 2003. The average linear expansion coefficient of the glass fiber-reinforced thermoplastic resin material can be obtained in accordance with JIS K 7197: 2012 by measuring a linear expansion coefficient in a flowing direction (MD direction) of a flat plate test piece, and a linear expansion coefficient in a direction crossing the MD direction at a right angle (TD direction), and obtaining an average of these.

In the metal-glass fiber-reinforced thermoplastic resin composite material of the present embodiment, the side of the metal material to be in contact with the glass fiber-reinforced thermoplastic resin material is preferably roughened entirely or partially by a known method to have unevenness.

In the metal-glass fiber-reinforced thermoplastic resin composite material of the present embodiment, examples of the thermoplastic resin included in the glass fiber-reinforced thermoplastic resin material can include polyethylene, polypropylene, polystyrene, styrene/maleic anhydride resins, styrene/maleimide resins, polyacrylonitrile, acrylonitrile/styrene (AS) resins, acrylonitrile/butadiene/styrene (ABS) resins, chlorinated polyethylene/acrylonitrile/styrene (ACS) resins, acrylonitrile/ethylene/styrene (AES) resins, acrylonitrile/styrene/methyl acrylate (ASA) resins, styrene/acrylonitrile (SAN) resins, methacrylic resins, polyvinyl chloride (PVC), polyvinylidene chloride (PVDC), polyamide, polyacetal, polyethylene terephthalate (PET), polybutylene terephthalate (PBT), polytrimethylene terephthalate (PTT), polycarbonate, polyarylene sulfide, polyethersulfone (PES), polyphenylsulfone (PPSU), polyphenylene ether (PPE), modified polyphenylene ether (m-PPE), polyaryl ether ketone, liquid crystal polymer (LCP), fluororesins, polyetherimide (PEI), polyarylate (PAR), polysulfone (PSF), polyamideimide (PAI), polyaminobismaleimide (PABM), thermoplastic polyimide (TPI), polyethylene naphthalate (PEN), ethylene/vinyl acetate (EVA) resins, ionomer (IO) resins, polybutadiene, styrene/butadiene resins, polybutylene, polymethylpentene, olefin/vinyl alcohol resins, cyclic olefin resins, cellulose resins, and polylactic acid.

Specific examples of the polyethylene can include high density polyethylene (HDPE), medium density polyethylene, low density polyethylene (LDPE), linear low density polyethylene (LLDPE), and ultra-high molecular weight polyethylene.

Examples of the polypropylene can include isotactic polypropylene, atactic polypropylene, syndiotactic polypropylene, and mixtures thereof.

Examples of the polystyrene can include general-purpose polystyrene (GPPS), which is an atactic polystyrene having an atactic structure, high impact polystyrene (HIPS) with a rubber component added to GPPS, and syndiotactic polystyrene having a syndiotactic structure.

Examples of the methacrylic resin can include polymers obtained by homopolymerizing one of acrylic acid, methacrylic acid, styrene, methyl acrylate, ethyl acrylate, ethyl methacrylate, butyl acrylate, butyl methacrylate, and fatty acid vinyl ester, or polymers obtained by copolymerizing two or more of these.

Examples of the polyvinyl chloride can include a vinyl chloride homopolymer, a copolymer of a vinyl chloride monomer and a copolymerizable monomer, or a graft copolymer obtained by graft polymerization of a vinyl chloride monomer to polymer polymerized by a conventionally known method such as emulsion polymerization method, suspension polymerization method, micro suspension polymerization method, or bulk polymerization method.

Examples of the polyamide can include one of components such as polycaproamide (polyamide 6), polyhexamethylene adipamide (polyamide 66), polytetramethylene adipamide (polyamide 46), polytetramethylene sebacamide (polyamide 410), polypentamethylene adipamide (polyamide 56), polypentamethylene sebacamide (polyamide 510), polyhexamethylene sebacamide (polyamide 610), polyhexamethylene dodecamide (polyamide 612), polydecamethylene adipamide (polyamide 106), polydecamethylene sebacamide (polyamide 1010), polydecamethylene dodecamide (polyamide 1012), polyundecanamide (polyamide 11), polyundecamethylene adipamide (polyamide 116), polydodecanamide (polyamide 12), polyxylene adipamide (polyamide XD6), polyxylene sebacamide (polyamide XD10), polymetaxylylene adipamide (polyamide MXD6), polyparaxylylene adipamide (polyamide PXD6), polytetramethylene terephthalamide (polyamide 4T), polypentamethylene terephthalamide (polyamide 5T), polyhexamethylene terephthalamide (polyamide 6T), polyhexamethylene isophthalamide (polyamide 6I), polynonamethylene terephthalamide (polyamide 9T), polydecamethylene terephthalamide (polyamide 10T), polyundecamethylene terephthalamide (polyamide 11T), polydodecamethylene terephthalamide (polyamide 12T), polytetramethylene isophthalamide (polyamide 4I), polybis(3-methyl-4-aminohexyl) methane terephthalamide (polyamide PACMT), polybis(3-methyl-4-aminohexyl) methane isophthalamide (polyamide PACMI), polybis(3-methyl-4-aminohexyl) methane dodecamide (polyamide PACM12), and polybis(3-methyl-4-aminohexyl) methane tetradecamide (polyamide PACM14), or copolymers obtained by combining two or more of the components, and mixtures thereof.

As the polyamide, a long-chain polyamide is preferred because of low water absorbency and excellent dimensional accuracy. The long-chain polyamide has an average number of carbon atoms, per nitrogen atom, of more than 9 and 30 or less, and examples include polyamide 11, polyamide 12, polyamide 1010, and polyamide 1012.

Examples of the polyacetal can include a homopolymer with oxymethylene units as the main repeating unit, and a copolymer mainly composed of oxymethylene units and containing oxyalkylene units having 2 to 8 adjacent carbon atoms in the main chain.

Examples of the polyethylene terephthalate can include polymers obtained by polycondensation of terephthalic acid or a derivative thereof with ethylene glycol.

Examples of the polybutylene terephthalate can include polymers obtained by polycondensation of terephthalic acid or a derivative thereof with 1,4-butanediol.

Examples of the polytrimethylene terephthalate can include polymers obtained by polycondensation of terephthalic acid or a derivative thereof with 1,3-propanediol.

Examples of the polycarbonate can include polymers that can be obtained by a transesterification method in which a dihydroxydiaryl compound is reacted with a carbonate such as diphenyl carbonate in a molten state; or polymers that can be obtained by a phosgene method in which a dihydroxyaryl compound is reacted with phosgene.

Examples of the polyarylene sulfide can include linear polyphenylene sulfide, crosslinked polyphenylene sulfide having a high molecular weight obtained by performing a curing reaction after polymerization, polyphenylene sulfide sulfone, polyphenylene sulfide ether, and polyphenylene sulfide ketone.

Examples of the polyphenylene ether can include poly(2,3-dimethyl-6-ethyl-1,4-phenylene ether), poly(2-methyl-6-chloromethyl-1,4-phenylene ether), poly(2-methyl-6-hydroxyethyl-1,4-phenylene ether), poly(2-methyl-6-n-butyl-1,4-phenylene ether), poly(2-ethyl-6-isopropyl-1,4-phenylene ether), poly(2-ethyl-6-n-propyl-1,4-phenylene ether), poly(2,3,6-trimethyl-1,4-phenylene ether), poly[2-(4′-methylphenyl)-1,4-phenylene ether], poly(2-bromo-6-phenyl-1,4-phenylene ether), poly(2-methyl-6-phenyl-1,4-phenylene ether), poly(2-phenyl-1,4-phenylene ether), poly(2-chloro-1,4-phenylene ether), poly(2-methyl-1,4-phenylene ether), poly(2-chloro-6-ethyl-1,4-phenylene ether), poly(2-chloro-6-bromo-1,4-phenylene ether), poly(2,6-di-n-propyl-1,4-phenylene ether), poly(2-methyl-6-isopropyl-1,4-phenylene ether), poly(2-chloro-6-methyl-1,4-phenylene ether), poly(2-methyl-6-ethyl-1,4-phenylene ether), poly(2,6-dibromo-1,4-phenylene ether), poly(2,6-dichloro-1,4-phenylene ether), poly(2,6-diethyl-1,4-phenylene ether), and poly(2,6-dimethyl-1,4-phenylene ether).

Examples of the modified polyphenylene ether can include a polymer alloy of poly(2,6-dimethyl-1,4-phenylene) ether and polystyrene; a polymer alloy of poly(2,6-dimethyl-1,4-phenylene) ether and a styrene/butadiene copolymer; a polymer alloy of poly(2,6-dimethyl-1,4-phenylene) ether and a styrene/maleic anhydride copolymer; a polymer alloy of poly(2,6-dimethyl-1,4-phenylene) ether and polyamide; a polymer alloy of poly(2,6-dimethyl-1,4-phenylene) ether and a styrene/butadiene/acrylonitrile copolymer; one obtained by introducing a functional group such as an amino group, an epoxy group, a carboxy group, a styryl group, or the like at the polymer chain end of the polyphenylene ether; and one obtained by introducing a functional group such as an amino group, an epoxy group, a carboxy group, a styryl group, a methacryl group, or the like at the polymer chain side chain of the polyphenylene ether.

Examples of the polyaryl ether ketone can include polyetherketone (PEK), polyetheretherketone (PEEK), polyetherketoneketone (PEKK), and polyetheretherketoneketone (PEEKK). As the polyaryl ether ketone, polyetheretherketone is preferable because of the amount distributed in the market and costs.

Examples of the liquid crystal polymer (LCP) can include a polymer (copolymer) composed of one or more structural units selected from aromatic hydroxycarbonyl units which are thermotropic liquid crystal polyesters, aromatic dihydroxy units, aromatic dicarbonyl units, aliphatic dihydroxy units, and aliphatic dicarbonyl units.

Examples of the fluororesin can include polytetrafluoroethylene (PTFE), perfluoroalkoxy resins (PFA), fluorinated ethylene propylene resins (FEP), fluorinated ethylene tetrafluoroethylene resins (ETFE), polyvinyl fluoride (PVF), polyvinylidene fluoride (PVDF), polychlorotrifluoroethylene (PCTFE), and ethylene/chlorotrifluoroethylene resin (ECTFE).

Examples of the ionomer (IO) resin can include copolymers of an olefin or a styrene and an unsaturated carboxylic acid, wherein a part of carboxyl groups is neutralized with a metal ion.

Examples of the olefin/vinyl alcohol resin can include ethylene/vinyl alcohol copolymers, propylene/vinyl alcohol copolymers, saponified products of ethylene/vinyl acetate copolymers, and saponified products of propylene/vinyl acetate copolymers.

Examples of the cyclic olefin resin can include monocyclic compounds such as cyclohexene, polycyclic compounds such as tetracyclopentadiene, and polymers of cyclic olefin monomers.

Examples of the polylactic acid can include poly-L-lactic acid, which is a homopolymer of L-form, poly-D-lactic acid, which is a homopolymer of D-form, or a stereocomplex polylactic acid which is a mixture thereof.

Examples of the cellulose resin can include methylcellulose, ethylcellulose, hydroxycellulose, hydroxymethylcellulose, hydroxyethylcellulose, hydroxyethyl methylcellulose, hydroxypropyl methylcellulose, cellulose acetate, cellulose propionate, and cellulose butyrate.

In the metal-glass fiber-reinforced thermoplastic resin composite material of the present embodiment, the thermoplastic resin included in the glass fiber-reinforced thermoplastic resin material is preferably one thermoplastic resin selected from the group consisting of polyphenylene sulfide, polyamide, polybutylene terephthalate, and polyaryl ether ketone because of mechanical properties, heat resistance, dielectric characteristics, chemical resistance, and productivity (molding temperature and fluidity), and preferably one thermoplastic resin selected from the group consisting of polyphenylene sulfide, polyamide, and polybutylene terephthalate further because of availability. The thermoplastic resin is further preferably polybutylene terephthalate, or polyphenylene sulfide, and particularly preferably polyphenylene sulfide because of a high degree of improvement of the heat cycle resistance. Besides, from the viewpoints of a high degree of improvement of the heat cycle resistance, and a high bonding strength value, the thermoplastic resin is particularly preferably polybutylene terephthalate.

In the metal-glass fiber-reinforced thermoplastic resin composite material of the present embodiment, the glass fiber-reinforced thermoplastic resin material can include components other than the glass fiber and the thermoplastic resin as long as the object of the present invention is not impaired. Examples of such components can include reinforcing fiber other than the glass fiber, a filler other than glass fiber, a flame retardant, a UV absorber, a heat stabilizer, an antioxidant, an antistatic agent, a fluidity improver, an anti-blocking agent, a lubricant, a nucleating agent, an antibacterial agent, and a pigment.

Examples of the reinforcing fiber other than the glass fiber include carbon fiber and metal fiber. Examples of the filler other than the glass fiber include a glass powder, talc, and mica.

In the metal-glass fiber-reinforced thermoplastic resin composite material of the present embodiment, the glass fiber-reinforced thermoplastic resin material can contain these components in the range of 0 to 40% by mass in total with respect to the total amount of the glass fiber-reinforced thermoplastic resin material.

In the metal-glass fiber-reinforced thermoplastic resin composite material of the present embodiment, the glass fiber-reinforced thermoplastic resin material may be located on the top side, the bottom side, or both the sides of the metal material in the form of a thin plate. The glass fiber-reinforced thermoplastic resin material may be located in contact entirely with any side of the metal material, or may be located in contact partially with any side of the metal material.

Applications of the metal-glass fiber-reinforced thermoplastic resin composite material of the present embodiment can include housings and parts such as frames of portable electronic devices including smartphones, automobile electrical parts such as battery tray covers, sensors, and coil bobbins, electronic device parts other than those for portable electronic devices, and electrical connecting terminal parts.

Examples and Comparative Examples of the present invention will be shown.

### EXAMPLES

### Examples 1 to 9

Glass fiber (chopped strand) having a SiO₂ content, a CaO content, Vickers hardness, a short diameter, a long diameter, a 500 poise temperature, and a 10000 poise temperature shown in Table 1, and having a cut length of 3 mm, and polyphenylene sulfide (manufactured by KUREHA CORPORATION, product name: Fortron KPSW-203A, shown as “PPS” in Table 1) were kneaded in a twin-screw kneader (manufactured by Shibaura Machine Co., Ltd., product name: TEM-26SS) at a screw rotation speed of 100 rpm to prepare a resin pellet having a glass content C shown in Table 1.

In Table 1, “SiO₂ Content”, and “CaO Content” are ratios with respect to the total amount of the glass fiber, and “Short Diameter” and “Long Diameter” are the short diameter and the long diameter of the glass filament constituting the glass fiber.

Next, stainless steel having been processed into a quadrangular prism of 14 mm×14 mm×25 mm (S50C, shown as “SUS” in Table 1) was fitted inside a mold of an injection molding machine (manufactured by Sodic Co., Ltd., product name: VRE40), and each of the resin pellets of Examples 1 to 9 was fed into the hopper of the injection molding machine heated to 310° C., and subjected to insert molding. As a result, a metal-glass fiber-reinforced thermoplastic resin composite material of each of Examples 1 to 9 in which a glass fiber-reinforced thermoplastic resin material of 21.8 mm×21.8 mm×21.8 mm was located on the surface of 14 mm×14 mm of the stainless steel was obtained.

Next, the metal-glass fiber-reinforced thermoplastic resin composite material of each of Examples 1 to 9 was evaluated for the heat cycle resistance, the productivity of the glass fiber, and the bending strength as an index of the mechanical strength of the glass fiber-reinforced thermoplastic resin material as follows. The results are shown in Table 1.

### Heat Cycle Resistance of Metal-Glass Fiber-Reinforced Thermoplastic Resin Composite Material

A low and high temperature resistance test was performed, in a cycle of which test, the metal-glass fiber-reinforced thermoplastic resin composite material of each of Examples 1 to 9 was left to stand at −40° C. for 30 minutes, then the temperature was raised to 180° C., the material was left to stand at 180° C. for 30 minutes, and the temperature was further lowered to −40° C. In the low and high temperature resistance test, it was checked, every 24 cycles, whether or not break had occurred in the interface between the metal material and the glass fiber-reinforced thermoplastic resin material, and thus, the heat cycle resistance of the metal-glass fiber-reinforced thermoplastic resin composite material was evaluated.

The heat cycle resistance was evaluated, in the low and high temperature resistance test, as “x” when break occurred on the interface within 48 cycles, was evaluated as “○” when break occurred within the range of more than 48 cycles and 168 cycles or less, and was evaluated as “⊚” when break did not occur within 168 cycles.

It is noted that “⊚” means excellent, “○” means good, and “x” means poor.

### Productivity of Glass Fiber

A glass batch prepared by mixing glass raw materials into the glass composition of each of Examples 1 to 9 was placed in a platinum crucible, and melted, with stirring, in an electric furnace by keeping a temperature of 1650° C. for 6 hours, and thus, homogenous molten glass was obtained. Next, the molten glass was poured onto a carbon plate to produce a glass cullet. Then, the glass cullet was charged in a platinum container, and the platinum container was heated to a temperature in the range of 1200 to 1450° C. to melt the glass cullet.

Next, the thus obtained molten glass was drawn through a nozzle tip of the platinum container to be wound around a winding device, and spinning was conducted by winding the molten glass by rotating the winding device for 1 hour at a rotational speed of 1100 rpm. At this point, the productivity of the glass fiber was evaluated as “⊚” when the spinning could be conducted continuously for 1 hour without cutting, was evaluated as “○” when the spinning could be conducted continuously for 30 minutes or more with cutting occurring once or twice during the 1 hour, and was evaluated as “x” otherwise.

It is noted that “⊚” means excellent, “○” means good, and “x” means poor.

### Bending Strength of Glass Fiber-Reinforced Thermoplastic Resin Material

The resin pellet obtained in each of Examples 1 to 9 was subjected to injection molding with an injection molding machine (manufactured by Nissei Plastic Industrial Co., Ltd., product name: NEX80) at a mold temperature of 90° C. and an injection temperature of 270° C. to produce a type A dumbbell test piece (thickness: 4 mm) in accordance with JIS K 7165: 2008. A measurement obtained from the type A dumbbell test piece by a static tensile test in accordance with JIS K 7171: 2016 with a precision universal tester (manufactured by Shimadzu Corporation, product name: Autograph AG-5000B) under a condition of a test temperature of 23° C. was determined as the bending strength of the glass fiber-reinforced thermoplastic resin material.

### Examples 10 to 16

Metal-glass fiber-reinforced thermoplastic resin composite materials of Examples 10 to 16 were obtained in the same manner as in Examples 1 to 9 except that glass fiber (chopped strand) having a SiO₂ content, a CaO content, Vickers hardness, a short diameter, a long diameter, a 500 poise temperature, and a 10000 poise temperature shown in Table 2, and having a cut length of 3 mm, and polybutylene terephthalate (manufactured by Polyplastics Co., Ltd., product name: DURANEX 2000, shown as “PBT” in Table 2) were kneaded in a twin-screw kneader (manufactured by Shibaura Machine Co., Ltd., product name: TEM-26SS) at a screw rotation speed of 100 rpm to prepare resin pellets having a glass content C shown in Table 2.

In Table 2, “SiO₂ Content”, and “CaO Content” are ratios with respect to the total amount of the glass fiber, and “Short Diameter” and “Long Diameter” are the short diameter and the long diameter of the glass filament constituting the glass fiber.

Next, the metal-glass fiber-reinforced thermoplastic resin composite material of each of Examples 10 to 16 was evaluated for the heat cycle resistance, the productivity of the glass fiber, and the bending strength as an index of the mechanical strength of the glass fiber-reinforced thermoplastic resin material completely in the same manner as in Examples 1 to 9. The results are shown in Table 2.

### Example 17

A metal-glass fiber-reinforced thermoplastic resin composite material of Example 17 was obtained completely in the same manner as in Example 1 except that an aluminum alloy (A5052, shown as “ALU” in Table 3) having been processed into a quadrangular prism of 14 mm×14 mm×25 mm was used instead of the stainless steel having been processed into a quadrangular prism of 14 mm×14 mm×25 mm.

Next, the metal-glass fiber-reinforced thermoplastic resin composite material of Example17 was evaluated for the heat cycle resistance, the productivity of the glass fiber, and the bending strength as an index of the mechanical strength of the glass fiber-reinforced thermoplastic resin material completely in the same manner as in Examples 1 to 9. The results are shown in Table 3.

### Comparative Examples 1 to 7

Metal-glass fiber-reinforced thermoplastic resin composite materials of Comparative Examples 1 to 7 were obtained completely in the same manner as in Examples 1 to 9 except that glass fiber (chopped strand) having a SiO₂ content, a CaO content, Vickers hardness, a short diameter, a long diameter, a 500 poise temperature, and a 10000 poise temperature shown in Table 4, and having a cut length of 3 mm, and polyphenylene sulfide (manufactured by KUREHA CORPORATION, product name: Fortron KPSW-203A, shown as “PPS” in Table 4) were kneaded in a twin-screw kneader (manufactured by Shibaura Machine Co., Ltd., product name: TEM-26SS) at a screw rotation speed of 100 rpm to prepare resin pellets having a glass content C shown in Table 4.

In Table 4, “SiO₂ Content”, and “CaO Content” are ratios with respect to the total amount of the glass fiber, and “Short Diameter” and “Long Diameter” are the short diameter and the long diameter of the glass filament constituting the glass fiber.

Next, the metal-glass fiber-reinforced thermoplastic resin composite material of each of Comparative Examples 1 to 7 was evaluated for the heat cycle resistance, the productivity of the glass fiber, and the bending strength as an index of the mechanical strength of the glass fiber-reinforced thermoplastic resin material completely in the same manner as in Examples 1 to 9. The results are shown in Table 4.

### Comparative Examples 8 to 14

Metal-glass fiber-reinforced thermoplastic resin composite materials of Comparative Examples 8 to 14 were obtained completely in the same manner as in Examples 1 to 9 except that glass fiber (chopped strand) having a SiO₂ content, a CaO content, Vickers hardness, a short diameter, a long diameter, a 500 poise temperature, and a 10000 poise temperature shown in Table 5, and having a cut length of 3 mm, and polybutylene terephthalate (manufactured by Polyplastics Co., Ltd., product name: DURANEX 2000, shown as “PBT” in Table 5) were kneaded in a twin-screw kneader (manufactured by Shibaura Machine Co., Ltd., product name: TEM-26SS) at a screw rotation speed of 100 rpm to prepare resin pellets having a glass content C shown in Table 5.

In Table 5, “SiO₂ Content”, and “CaO Content” are ratios with respect to the total amount of the glass fiber, and “Short Diameter” and “Long Diameter” are the short diameter and the long diameter of the glass filament constituting the glass fiber.

Next, the metal-glass fiber-reinforced thermoplastic resin composite material of each of Comparative Examples 8 to 14 was evaluated for the heat cycle resistance, the productivity of the glass fiber, and the bending strength as an index of the mechanical strength of the glass fiber-reinforced thermoplastic resin material completely in the same manner as in Examples 1 to 9. The results are shown in Table 5.

TABLE 1

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Glass | Vickers Hardness H | 740 | 740 | 740 | 740 | 740 | 740 | 740 | 730 | 750 |
| Fiber | (HV0.2) | | | | | | | | | |
| | Short Diameter (μm) | 8.8 | 8.8 | 8.8 | 7.0 | 7.0 | 8.8 | 10.0 | 8.8 | 7.0 |
| | Long Diameter (μm) | 28.2 | 28.2 | 28.2 | 26.6 | 26.6 | 28.2 | 20.0 | 28.2 | 26.6 |
| | Long Diameter/Short | 3.2 | 3.2 | 3.2 | 3.8 | 3.8 | 3.2 | 2.0 | 3.2 | 3.8 |
| | Diameter A | | | | | | | | | |
| | 500 Poise Temperature | 1245 | 1245 | 1245 | 1245 | 1245 | 1245 | 1245 | 1235 | 1250 |
| | T1 (° C.) | | | | | | | | | |
| | 10000 Poise Temperature | 1075 | 1075 | 1075 | 1075 | 1075 | 1075 | 1075 | 1055 | 1090 |
| | T2 (° C.) | | | | | | | | | |
| | ΔT (° C.) | 170 | 170 | 170 | 170 | 170 | 170 | 170 | 180 | 160 |
| | SiO₂ Content (mass %) | 55 | 55 | 55 | 55 | 55 | 55 | 55 | 52 | 59 |
| | CaO Content (mass %) | 23 | 23 | 23 | 23 | 23 | 23 | 23 | 25 | 21 |

| | | | | | | | | | |
|---|---|---|---|---|---|---|---|---|---|
| Glass Content C (mass %) | 35 | 40 | 45 | 35 | 30 | 60 | 35 | 35 | 35 |
| H × C¹²/(A × ΔT) | 8.05 | 8.60 | 9.13 | 6.78 | 6.27 | 10.54 | 12.88 | 7.50 | 7.30 |
| Resin | PPS | PPS | PPS | PPS | PPS | PPS | PPS | PPS | PPS |
| Metal | SUS | SUS | SUS | SUS | SUS | SUS | SUS | SUS | SUS |
| Heat Cycle Resistance | ⊚ | ⊚ | ⊚ | ⊚ | ⊚ | ◯ | ◯ | ⊚ | ⊚ |
| Productivity of Glass Fiber | ⊚ | ⊚ | ⊚ | ⊚ | ⊚ | ⊚ | ⊚ | ⊚ | ⊚ |
| Bending Strength (MPa) | 204 | 220 | 235 | 198 | 183 | 250 | 206 | 202 | 201 |

TABLE 2

| | | Example | Example | Example | Example | Example | Example | Example |
|---|---|---|---|---|---|---|---|---|
| | | 10 | 11 | 12 | 13 | 14 | 15 | 16 |
| Glass | Vickers Hardness H | 740 | 740 | 740 | 740 | 740 | 740 | 740 |
| Fiber | (HV0.2) | | | | | | | |
| | Short Diameter (μm) | 8.8 | 8.8 | 8.8 | 7.0 | 7.0 | 8.8 | 8.6 |
| | Long Diameter (μm) | 28.2 | 28.2 | 28.2 | 26.6 | 26.6 | 28.2 | 28.4 |
| | Long Diameter/Short | 3.2 | 3.2 | 3.2 | 3.8 | 3.8 | 3.2 | 3.3 |
| | Diameter A | | | | | | | |
| | 500 Poise Temperature | 1245 | 1245 | 1245 | 1245 | 1245 | 1245 | 1245 |
| | T1 (° C.) | | | | | | | |
| | 10000 Poise Temperature | 1075 | 1075 | 1075 | 1075 | 1075 | 1075 | 1075 |
| | T2 (° C.) | | | | | | | |
| | ΔT (° C.) | 170 | 170 | 170 | 170 | 170 | 170 | 170 |
| | SiO₂ Content (mass %) | 55 | 55 | 55 | 55 | 55 | 55 | 55 |
| | CaO Content (mass %) | 23 | 23 | 23 | 23 | 23 | 23 | 23 |

| | | | | | | | |
|---|---|---|---|---|---|---|---|
| Glass Content C (mass %) | 35 | 40 | 45 | 35 | 30 | 60 | 25 |
| H × C¹²/(A × ΔT) | 8.05 | 8.60 | 9.13 | 6.78 | 6.27 | 10.54 | 6.60 |
| Resin | PBT | PBT | PBT | PBT | PBT | PBT | PBT |
| Metal | SUS | SUS | SUS | SUS | SUS | SUS | SUS |
| Heat Cycle Resistance | ⊚ | ⊚ | ⊚ | ⊚ | ◯ | ◯ | ◯ |
| Productivity of Glass Fiber | ⊚ | ⊚ | ⊚ | ⊚ | ⊚ | ⊚ | ⊚ |
| Bending Strength (MPa) | 225 | 240 | 250 | 225 | 228 | 210 | 185 |

TABLE 3

| | | Example 17 |
|---|---|---|
| Glass | Vickers Hardness H (HV0.2) | 740 |
| Fiber | Short Diameter (μm) | 8.8 |
| | Long Diameter (μm) | 28.2 |
| | Long Diameter/Short Diameter A | 3.2 |
| | 500 Poise Temperature T1 (° C.) | 1245 |
| | 10000 Poise Temperature T2 (° C.) | 1075 |
| | ΔT (° C.) | 170 |
| | SiO₂ Content (mass %) | 55 |
| | CaO Content (mass %) | 23 |

| | |
|---|---|
| Glass Content C (mass %) | 35 |
| H × C^{1/2}/(A × ΔT) | 8.05 |
| Resin | PPS |
| Metal | ALU |
| Heat Cycle Resistance | ⊚ |
| Productivity of Glass Fiber | ⊚ |
| Bending Strength (MPa) | 204 |

TABLE 4

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Glass | Vickers Hardness H | 775 | 770 | 670 | 740 | 670 | 670 | 740 |
| Fiber | (HV0.2) | | | | | | | |
| | Short Diameter (μm) | 13.0 | 10.0 | 7.0 | 5.5 | 5.5 | 4.5 | 13.0 |
| | Long Diameter (μm) | 13.0 | 20.0 | 28.0 | 31.4 | 31.4 | 35.1 | 13.0 |
| | Long Diameter/Short | 1.0 | 2.0 | 4.0 | 5.7 | 5.7 | 7.8 | 1.0 |
| | Diameter A | | | | | | | |
| | 500 Poise Temperature | 1515 | 1515 | 1377 | 1245 | 1377 | 1377 | 1245 |
| | T1 (° C.) | | | | | | | |
| | 10000 Poise Temperature | 1360 | 1360 | 1185 | 1075 | 1185 | 1185 | 1075 |
| | T2 (° C.) | | | | | | | |
| | ΔT (° C.) | 155 | 155 | 192 | 170 | 192 | 192 | 170 |
| | SiO₂ Content (mass %) | 65 | 65 | 55 | 55 | 55 | 55 | 55 |
| | CaO Content (mass %) | 0 | 0 | 5 | 23 | 5 | 5 | 23 |

| | | | | | | | |
|---|---|---|---|---|---|---|---|
| Glass Content C (mass %) | 35 | 35 | 35 | 35 | 35 | 35 | 35 |
| H × C¹²/(A × ΔT) | 29.58 | 14.69 | 5.16 | 4.52 | 3.62 | 2.65 | 25.75 |
| Resin | PPS | PPS | PPS | PPS | PPS | PPS | PPS |
| Metal | SUS | SUS | SUS | SUS | SUS | SUS | SUS |
| Heat Cycle Resistance | X | ⊚ | X | ⊚ | ⊚ | ⊚ | X |
| Productivity of Glass Fiber | ◯ | X | ◯ | X | ◯ | X | ⊚ |
| Bending Strength (MPa) | 218 | 224 | 185 | 188 | 175 | 168 | 206 |

TABLE 5

| | | Comparative | Comparative | Comparative | Comparative | Comparative | Comparative | Comparative |
|---|---|---|---|---|---|---|---|---|
| | | Example 8 | Example 9 | Example 10 | Example 11 | Example 12 | Example 13 | Example 14 |
| Glass | Vickers Hardness H | 775 | 770 | 670 | 740 | 670 | 670 | 740 |
| Fiber | (HV0.2) | | | | | | | |
| | Short Diameter (μm) | 13.0 | 10.0 | 7.0 | 5.5 | 5.5 | 4.5 | 13.0 |
| | Long Diameter (μm) | 13.0 | 20.0 | 28.0 | 31.4 | 31.4 | 35.1 | 13.0 |
| | Long Diameter/Short | 1.0 | 2.0 | 4.0 | 5.7 | 5.7 | 7.8 | 1.0 |
| | Diameter A | | | | | | | |
| | 500 Poise Temperature | 1515 | 1515 | 1377 | 1245 | 1377 | 1377 | 1245 |
| | T1 (° C.) | | | | | | | |
| | 10000 Poise Temperature | 1360 | 1360 | 1185 | 1075 | 1185 | 1185 | 1075 |
| | T2 (° C.) | | | | | | | |
| | ΔT(° C.) | 155 | 155 | 192 | 170 | 192 | 192 | 170 |
| | SiO₂ Content (mass %) | 65 | 65 | 55 | 55 | 55 | 55 | 55 |
| | CaO Content (mass %) | 0 | 0 | 5 | 23 | 5 | 5 | 23 |

| | | | | | | | |
|---|---|---|---|---|---|---|---|
| Glass Content C (mass %) | 35 | 35 | 35 | 35 | 35 | 35 | 35 |
| H × C¹²/(A × ΔT) | 29.58 | 14.69 | 5.16 | 4.52 | 3.62 | 2.65 | 25.75 |
| Resin | PBT | PBT | PBT | PBT | PBT | PBT | PBT |
| Metal | SUS | SUS | SUS | SUS | SUS | SUS | SUS |
| Heat Cycle Resistance | X | ⊚ | X | ⊚ | X | ⊚ | X |
| Productivity of Glass Fiber | ◯ | X | ◯ | X | ◯ | X | ⊚ |
| Bending Strength (MPa) | 252 | 255 | 216 | 218 | 210 | 205 | 225 |

It is obvious, from Tables 1, 2, and 3, that according to the metal-glass fiber-reinforced thermoplastic resin composite materials of Examples 1 to 16 in which the difference ΔT (ΔT=T1−T2) between the 500 poise temperature T1 and the 10000 poise temperature T2 is in the range of 157 to 186° C., the ratio (long diameter/short diameter) A of the long diameter to the short diameter of the glass filament is in the range of 1.5 to 4.5, and the glass content C of the glass fiber-reinforced thermoplastic resin material is in the range of 20.0 to 65.0% by mass, the productivity of the glass fiber, and the mechanical strength of the glass fiber-reinforced thermoplastic resin material are high, and excellent heat cycle resistance can be provided between the metal material and the glass fiber-reinforced thermoplastic resin material.

On the other hand, it is obvious, from Tables 4 and 5, that according to the metal-glass fiber-reinforced thermoplastic resin composite materials of Comparative Examples 1 to 14 in which any one or more of the difference ΔT (ΔT=T1−T2) between the 500 poise temperature T1 and the 10000 poise temperature T2, the ratio (long diameter/short diameter) A of the long diameter to the short diameter of the glass fiber, and the glass content C of the glass fiber-reinforced thermoplastic resin material are out of the above-described ranges, any one of the productivity of the glass fiber, the mechanical strength of the glass fiber-reinforced thermoplastic resin material, and the heat cycle resistance between the metal material and the glass fiber-reinforced thermoplastic resin material is insufficient.

In Example 1, the absolute value of the difference between the linear expansion coefficient of the metal material and the average linear expansion coefficient of the glass fiber-reinforced thermoplastic resin material was 3.6×10⁻⁵/° C., and break was found to occur in 360 cycles in the evaluation of the heat cycle resistance. On the other hand, in Example 17, the absolute value of the difference between the linear expansion coefficient of the metal material and the average linear expansion coefficient of the glass fiber-reinforced thermoplastic resin material was 2.4×10⁻⁵/° C., and break was not found to occur in 480 cycles in the evaluation of the heat cycle resistance.

1. A metal-glass fiber-reinforced thermoplastic resin composite material comprising a metal material, and a glass fiber-reinforced thermoplastic resin material disposed on at least one side of the metal material,
wherein a difference ΔT (ΔT=T1−T2) between a 500 poise temperature T1 and a 10000 poise temperature T2 of glass fiber included in the glass fiber-reinforced thermoplastic resin material is in a temperature range of 157 to 186° C.,
a glass filament constituting the glass fiber has a flat cross-sectional shape having a ratio (long diameter/short diameter) A of a long diameter to a short diameter of the glass filament in a range of 1.5 to 4.5, and
a glass content C of the glass fiber-reinforced thermoplastic resin material is in a range of 20.0 to 65.0% by mass.

2. The metal-glass fiber-reinforced thermoplastic resin composite material according to claim 1, wherein the glass fiber included in the glass fiber-reinforced thermoplastic resin material has a Vickers hardness H in a range of 700 to 800 HV0.2, and the A, the C, the ΔT, and the H satisfy following formula (1):
$$6.53 \leq H \times {C}^{1 / 2} / ( A \times Δ T ) \leq 13.45 \qquad ( 1 )$$

3. The metal-glass fiber-reinforced thermoplastic resin composite material according to claim 2, wherein the A, the C, the ΔT, and the H satisfy following formula (2):
$$5.72 \leq H \times {C}^{1 / 2} / ( A \times Δ T ) \leq 9.83 \qquad ( 2 )$$

4. The metal-glass fiber-reinforced thermoplastic resin composite material according to claim 1, wherein a thermoplastic resin included in the glass fiber-reinforced thermoplastic resin material is one thermoplastic resin selected from the group consisting of polyphenylene sulfide, polyamide, polybutylene terephthalate, and polycarbonate.
